(19) United States
(12) Patent Application Publication
(10) Pub. No.: US 2009/0031905 A1
(43) Pub. Date: Feb. 5, 2009

(54) ROTARY SCREEN PRINTING USING MANDRELS

(76) Inventor: John B. HOWARD, Wildwood, MO (US)

Correspondence Address: FOLEY AND LARDNER LLP;SUITE 500, 3000 K STREET NW, WASHINGTON, DC, 20007, US

(21) Appl. No.: 11/833,638

(22) Filed: Aug. 3, 2007

(51) Int. Cl. B41L 13/04

(52) U.S. Cl. 101/116

(57) ABSTRACT

A printing press, comprising: two mandrels positioned with axes aligned and in parallel; a plurality of wheel elements, with a different one of the wheel elements disposed around each end of each of the mandrels, wherein at least one of the wheel elements on one of the mandrels is a drive wheel; a rotary screen extending lengthwise between and around the wheel elements at the ends of the mandrels; and an ink repository positioned to provide ink to the rotary screen.

### BACKGROUND OF THE DISCLOSURE

It is useful to invent new and non-obvious ways to perform rotary screen printing.

### SUMMARY

In one embodiment, a printing press is provided, comprising: two mandrels positioned with axes aligned and in parallel; a plurality of wheel elements, with a different one of the wheel elements disposed around each end of each of the mandrels, wherein at least one of the wheel elements on one of the mandrels is a drive wheel; a rotary screen extending lengthwise between and around the wheel elements at the ends of the mandrels; and an ink repository positioned to provide ink to the rotary screen.

In a further embodiment, each of the wheel elements comprises a unitary wheel.

In a yet further embodiment, the wheel elements at each mandrel comprise large diameter ends of a sleeve disposed around the mandrel, with the sleeve having a smaller diameter portion relative to the large diameter ends in between the large diameter ends.

In a yet further embodiment, the ink repository is disposed in a space around the sleeve between the large diameter ends of at least one of the mandrels.

In a yet further embodiment, a plurality of sleeves are provided, a different sleeve disposed around each different mandrel.

In a yet further embodiment, a plurality of flexible bands are provided, at least one flexible band extending over the rotary screen and around each wheel element and co-extensive with a portion of the rotary screen.

In a yet further embodiment, the flexible bands are attached to the rotary screen.

In a yet further embodiment, means is provided for facilitating movement of at least one of the mandrels toward or away from the other of the mandrels to provide lengthwise tensioning of the rotary screen.

In a yet further embodiment, means is providing for lateral tensioning of the rotary screen. In one embodiment, the means for providing lateral tensioning comprises a flexible band extending around each wheel element and co-extensive with a portion of the rotary screen, wherein the flexible band is made with an outward camber. In another embodiment, the means for providing lateral tensioning comprises a flexible band extending around each wheel element and co-extensive with a portion of the rotary screen, and a nip wheel running on the flexible band with a canted axis relative to the axis of the mandrel.

In a yet further embodiment, the two wheel elements disposed at opposite ends of the one of the mandrels are drive wheels, and wherein the means for providing lateral tensioning comprises an axis of rotation of the two drive wheel elements being disposed at an outward angle relative to the axis of the one mandrel on which it is disposed.

In a yet further embodiment, the ink repository is disposed between the wheel elements on at least one of the mandrels adjacent the rotary screen and includes therein an element for forcing ink through the rotary screen to a substrate, wherein the element for forcing ink is radially adjustable and/or tangentially adjustable relative to the rotary screen. In one embodiment, the element for forcing ink comprises a squeegee holder holding a squeegee, with the squeegee holder rotating around an eccentric disposed around one of the mandrels to adjust the squeegee radially. In another embodiment, the element for forcing ink comprises a squeegee holder holding a squeegee and rotating around an eccentric disposed around one of the mandrels to adjust the squeegee radially, wherein the eccentric is rotatable to adjust the squeegee tangentially.

### BRIEF DESCRIPTION OF THE DRAWINGS

FIG. 1 is a perspective view of one embodiment of the invention,

FIG. 2A is an end view of one embodiment of a mandrel with a squeegee, squeegee holder and eccentric.

FIGS. 2B, 2C and 2D illustrate various adjustment positions for the squeegee holder.

FIG. 3 is a side view of an embodiment with two mandrels and a rotary screen.

FIG. 4 is a perspective view of the rotary screen with bands at each lateral end thereof.

FIG. 5 is a view of a mandrel with a sleeve therearound and wheel elements disposed at either end.

FIG. 6 is a side view of the rotary screen and adjustable squeegee.

FIG. 7A is a side view of the rotary screen, squeegee, squeegee holder and eccentric.

FIG. 7B is a sectional view of FIG. 7A.

FIG. 8A is a schematic drawing illustrating a cambered band.

FIG. 8B is a schematic drawing illustrating two cambered bands, one bonded to each lateral edge of a screen.

FIG. 8C is a schematic drawing illustrating two cambered bands boned to a screen in the context of the mandrels and wheel elements.

FIG. 9 is a side view showing a nip wheel with a mandrel wheel.

FIG. 10 is a schematic drawing showing the axes of the wheel relative to the axis of rotation of the nip wheel.

FIG. 11 is a schematic drawing showing the axes of the drive wheel elements angled outward from the screen.

### DETAILED DESCRIPTION OF THE EMBODIMENTS

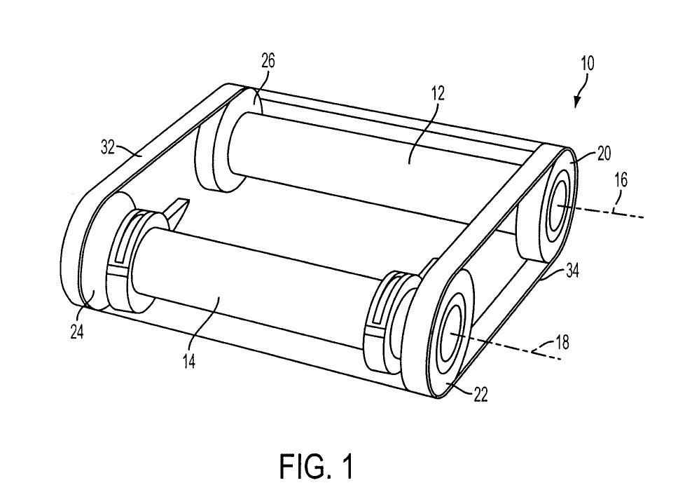

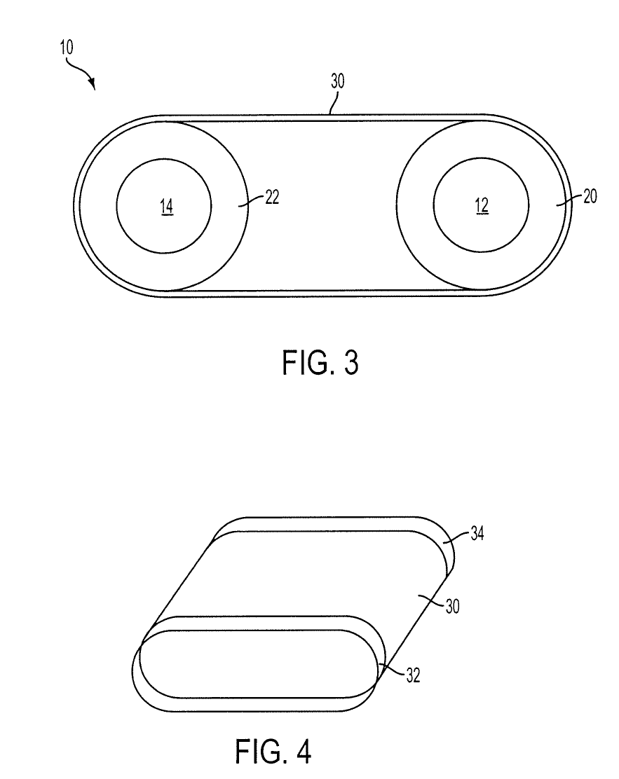

Referring to FIGS. 1-3, a first exemplary embodiment is shown illustrating a screen printing press 10, comprising two mandrels 12 and 14 positioned with their respective axes 16 and 18 aligned and in parallel. A plurality of wheel elements 20, 22, 24 and 26 are provided, with one of the wheel elements disposed around each end of each of the mandrels 12 and 14. In one embodiment, at least one of the wheel elements on one of the mandrels is a drive wheel. In a further embodiment, the wheel elements on each end of the mandrel 12 may be drive wheel elements. In one embodiment, the wheel elements may each comprise a unitary wheel disposed around an end of a mandrel. In another embodiment, the wheel elements at each mandrel comprise large diameter ends of a sleeve disposed around the mandrel, with the sleeve having a smaller diameter portion relative to the large diameter ends in between the large diameter ends. In this embodiment, the ink repository may be disposed in a space around the sleeve between the large diameter ends for at least one of the mandrels.

A rotary screen 30 in the shape of an oblong endless belt extends lengthwise between and around the wheel elements 20-26 at the ends of the mandrels. In one embodiment, the rotary screen 30 may be exemplified by the Rotomesh product provided by the supplier Stork Prints. In one embodiment, the traditional rigid circular end rings for the screen 30 may be replaced by a plurality of flexible bands, at least one flexible band extending over the rotary screen and around each wheel element and co-extensive with the rotary screen. In one embodiment, the flexible bands are attached to the rotary screen. Examples of the flexible bands comprise bands 32 and 34 disposed substantially at each lateral edge of the screen 30, as shown in FIG. 4.

These flexible bands 32 and 34 could be made of a variety of materials including a metal alloy, or rubber or plastic, depending on the desired flexibility characteristics and tensioning requirements of the application. The flexible bands, in one embodiment, may be bonded to the material of the rotary screen 30, for example, by means of heat, molding, or soldering, among other ways. In one embodiment, the flexible bands are capable of being tensioned such that one or more of the drive wheel elements could drive the flexible bands.

An ink repository is positioned to provide ink to the rotary screen. In one embodiment, the ink repository is disposed in a volume between the wheel elements on at least one of the mandrels adjacent the rotary screen. This ink repository may include an element for forcing ink through the rotary screen to a substrate, wherein the element for forcing ink is radially adjustable and/or tangentially adjustable relative to the rotary screen.

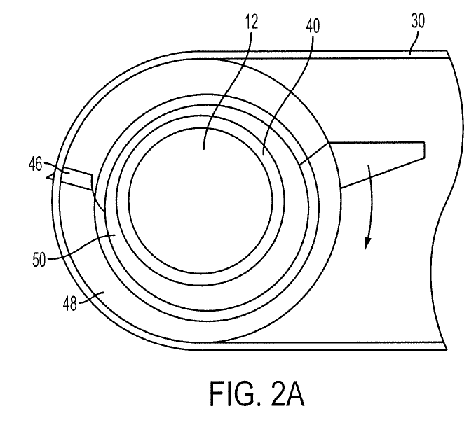

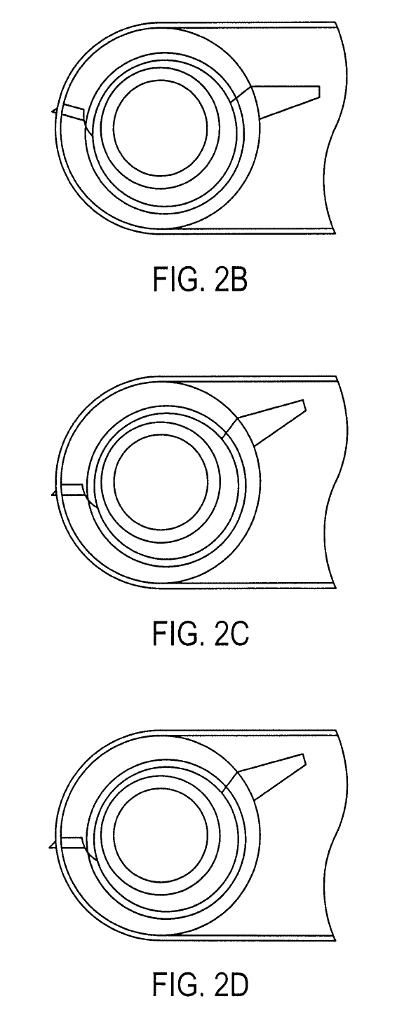

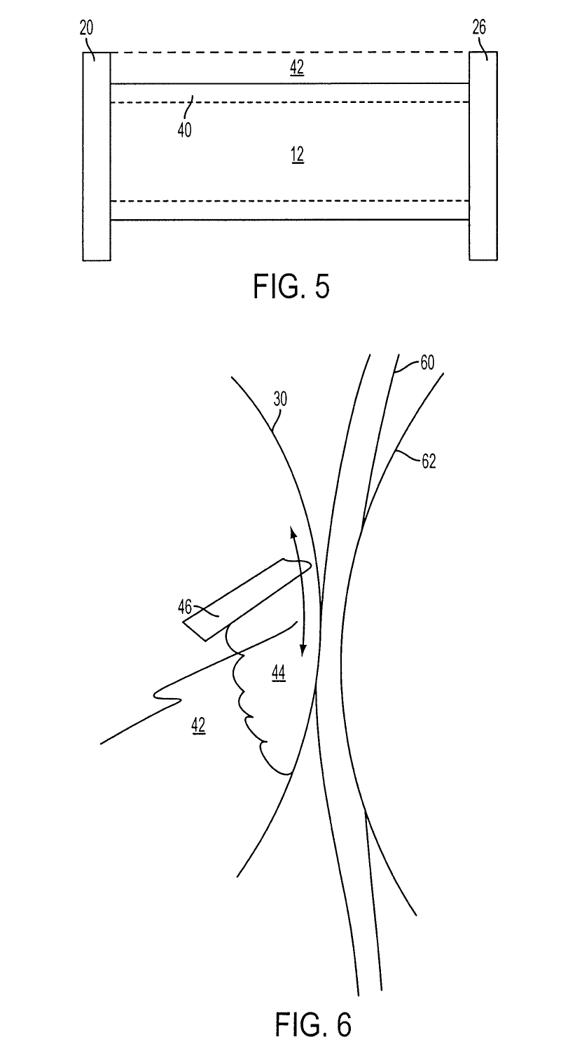

Referring to FIGS. 2 and 5, in one embodiment, a sleeve 40 may be disposed over at least one of the mandrels, e.g., mandrel 12, or both of the mandrels 12 and 14. The sleeve 40 has a larger diameter than the outer diameter of the mandrel 12, with the space between the sleeve 40 and the outer diameter of the mandrel, illustrated in FIG. 5 with dashed lines, filled with pressurized air. In one embodiment, when the wheel elements on one side, e.g., 20 and 22, are removed, then the sleeve 40 and rotary screen 30 can be slid off the mandrels for servicing or replacement.

In one embodiment, the volume 42 in FIG. 5 between the outer diameter of the sleeve 40 and the outer diameter of the wheel elements 20 and 26 may be used as an ink repository 42 and to fit a squeegee 46. See FIGS. 2, 6 and 7. The squeegee 46 may be used to force ink through the screen mesh to a substrate 60 to be inked. Note that the roll 62 in FIG. 6 is an impression roll.

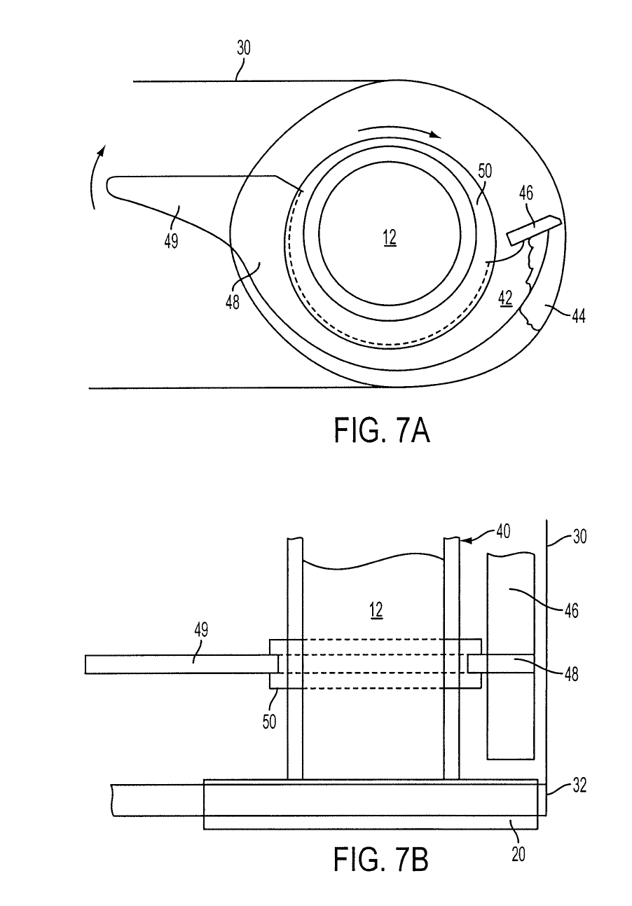

In one embodiment, the squeegee 46 may be adjustable tangentially and/or radially. A squeegee holder 48 holding the squeegee 46 is provided to make the adjustment. See FIGS. 2, 7A and 7B. In one embodiment, a handle 49 for the squeegee holder 48 extends out axially beyond the mandrels so that it is accessible. See FIG. 7B. The squeegee holder 48, in one embodiment, may be disposed to rotate around an eccentric 50 which is disposed around one of the mandrels to thereby adjust the squeegee radially. See FIGS. 2A-2D, 7A and 7B. Note that FIG. 7B is a cross-sectioned of FIG. 7A. Rotating the squeegee holder 48 around the eccentric 50 adjusts the squeegee toward or away from the screen 30, i.e., adjusts it along the radius of the screen.

In a further embodiment, the squeegee 46 may be adjustable tangentially, i.e., the point where the squeegee 46 is located relative to the screen circumference is adjustable. This tangential adjustment may be accomplished by rotating the eccentric 50 around the mandrel 12. Note that rotating the squeegee holder 48 around the eccentric also adjusts the point where the squeegee 46 is located relative to the circumference of the screen, i.e., the tangential point. But, as described above, rotating the squeegee holder 48 relative to the eccentric will adjust the squeegee 46 both radially and tangentially. Thus, the eccentric 50 may need to be rotated if the radial location is to be adjusted, but the tangential point is to remain the same.

In a further embodiment, a configuration may be provided to adjust the tension on the screen 30 lengthwise and/or laterally. One embodiment for tensioning the screen lengthwise comprises controlling a distance between the two mandrels 12 and 14. This control may be accomplished by disposing one or both of the mandrels on moveable dock assemblies that are disposed on tracks running parallel to the direction of adjustment. Note that there are a variety of other mechanisms that can be used to adjust the relative spacing of the mandrels 12 and 14. Another method of adjusting the mandrel position comprises fixing the position of one mandrel and mounting another mandrel on a frame with an eccentric bushing. Alternatively, one mandrel of a mandrel pair could be mounted on radius arms that are free to move around a pivot point.

Some embodiments of the present invention utilize transducers or the like to evaluate the locations of the mandrels and determine proper locations for a desired tensioning. In some embodiments, there are sensors that sense the torque on a motor that moves the mandrels. This torque measurement is then used to control distance between the mandrels in a feedback loop. Thus, the separation distance of the mandrels that are used as pulleys for the rotary screen are determined automatically by a computer system or the like or logic having a feed-back loop, and/or the press includes a control system to automatically move the mandrels so that the proper tension is obtained. In other embodiments, a manual system may be utilized where a press operator controls the adjustment of the distances.

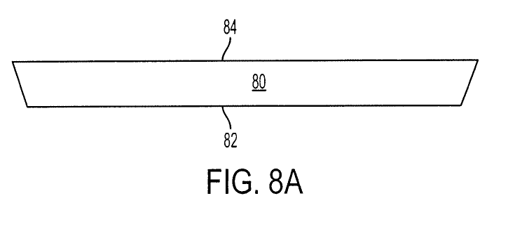

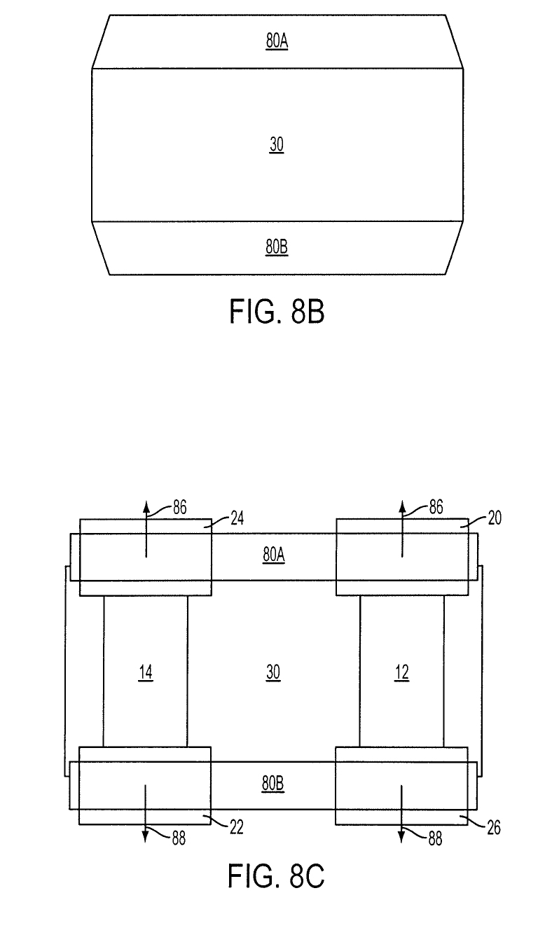

Some embodiments provide a method and structure to provide lateral tensioning across the width of the rotary screen 30. In one embodiment for accomplishing this lateral tensioning, one or both of the flexible bands 32 and 34 that extend around and over each wheel and are attached or otherwise are bonded at each lateral edge to the rotary screen are made with an outward camber. Such as outward camber on one or both of the flexible bands bonded on either lateral side of the screen 30 would track/walk one or both of the bands laterally, thereby tensioning the screen 30. An example of this camber is shown in FIG. 8A. FIG. 8A shows a cambered flexible band 80 with a side 82 which is shorter than a side 84 thereof. When the band 80 is joined end-to-end, the ends of the side 82 will need to be stretched to join the ends thereof. Thus, when the flexible band 80 is tensioned over a wheel surface, such as a drive wheel surface, side 82 is tensioned more than side 84. Although the inventor is not limited to a particular theoretical understanding, it is believed that the normal entry rule provides that a resultant tension vector in the flexible band 80 will try to align parallel to a plane in which the wheel rotates and normal to the wheel's axis of rotation. At some point an equilibrium is reached between the normal entry rule and traction for the lateral force. Thus, it is the inventor's understanding that two cambered bands 80A and 80B in FIG. 8B, running, for example, over two parallel drive wheel elements, as shown in FIG. 8C, will generate opposite lateral forces that will tension screen 30 laterally across the web in FIG. 8C. There will be tracking/walking toward the respective short sides 82 until the lateral force generated equals the traction between the bands 80A and 80B and the drive wheel elements. FIG. 8B illustrates the two flexible bands 80A and 80B, each cambered outwardly and creating two opposing lateral forces, designated by the opposing force arrows 86 and 88 shown in FIG. 8C. Increasing the tension applied to the flexible bands 80A and 80B will increase the lateral force generated. Note that although two cambered flexible bands 80 are illustrated in the FIGS. 8B and 8C, lateral tensioning of the screen may be achieved using only one cambered band. Also, note that the present cambered design may be applied to any printing application wherein lateral tensioning is needed for an endless loop flexible material, such as a flexographic plate sleeve, an anilox sleeve, a gravure imaged sleeve, a lithographic offset blanket or plate, or other printing related surface.

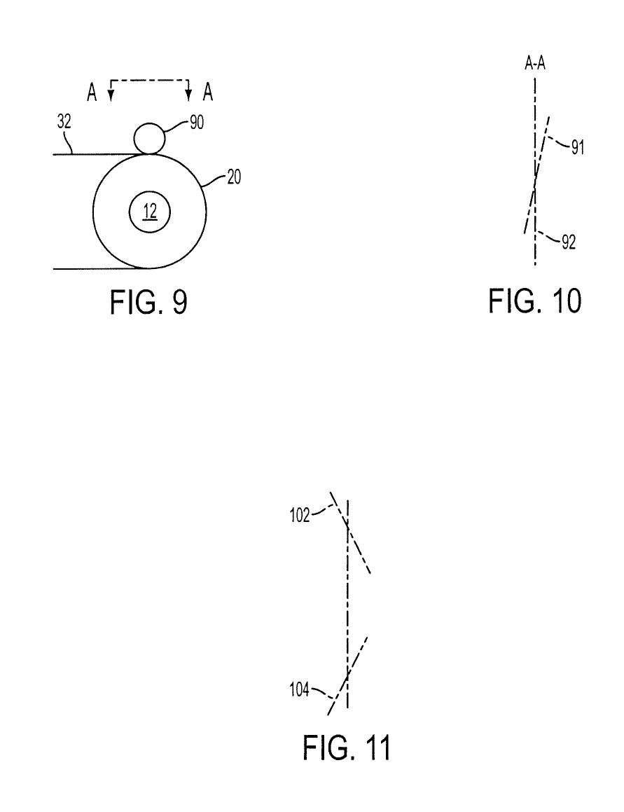

In a further embodiment for accomplishing lateral tensioning, the flexible bands 32 and 34 are provided that extend around and over each wheel and are attached or otherwise are bonded to the rotary screen 30. As shown in FIG. 9, a nip wheel 90 is provided running on the flexible band 32 and supported by the wheel 20. As shown in FIG. 10, the nip wheel 90 is provided with a canted axis 91 relative to the axis 92 of the wheel 20. The normal force provided by this canting as well as the coefficient of friction may generate a lateral force to provide lateral tensioning. Additionally, to increase lateral tensioning, the axes of rotation 102 and 104 of one or both wheel elements on a given mandrel, for example the drive wheel elements in one embodiment, may be canted/angled outwardly relative to the screen, as shown in FIG. 11.

It is noted that in some embodiments of the present invention, the press includes a controller, which may be a simple processor, that is configured to control the press in an automatic function, and to automatically identify pacing factors and registration factors to obtain desired processing performance. The present invention includes methods to practicing the invention, software to practice the invention, logic (that is hardware and or software and or firmware, etc.), and apparatuses configured to implement the present invention. Accordingly, the present invention includes a program product and hardware and firmware for implementing algorithms to practice the present invention, as well as the systems and methods described herein, and also for the control of the devices and implementation of the methods described herein. It is noted that the term “processor,” as used herein, encompasses both simple circuits and complex circuits, as well as computer processors.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or manual operations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A printing press, comprising:
two mandrels positioned with axes aligned and in parallel;
a plurality of wheel elements, with a different one of the wheel elements disposed around each end of each of the mandrels, wherein at least one of the wheel elements on one of the mandrels is a drive wheel;
a rotary screen extending lengthwise between and around the wheel elements at the ends of the mandrels; and
an ink repository positioned to provide ink to the rotary screen.

2. The printing press as defined in claim 1, wherein each of the wheel elements comprises a unitary wheel.

3. The printing press as defined in claim 1, wherein the wheel elements at each mandrel comprise large diameter ends of a sleeve disposed around the mandrel, with the sleeve having a smaller diameter portion relative to the large diameter ends in between the large diameter ends.

4. The printing press as defined in claim 3, wherein the ink repository is disposed in a space around the sleeve between the large diameter ends of at least one of the mandrels.

5. The printing press as defined in claim 1, further comprising:
a plurality of sleeves, a different sleeve disposed around each different mandrel.

6. The printing press as defined in claim 1, further comprising a plurality of flexible bands, at least one flexible band extending over the rotary screen and around each wheel element and co-extensive with a portion of the rotary screen.

7. The printing press as defined in claim 6, wherein the flexible bands are attached to the rotary screen.

8. The printing press as defined in claim 1, further comprising:
means for facilitating movement of at least one of the mandrels toward or away from the other of the mandrels to provide lengthwise tensioning of the rotary screen.

9. The printing press as defined in claim 1, further comprising:
means for providing lateral tensioning of the rotary screen.

10. The printing press as defined in claim 9, wherein the means for providing lateral tensioning comprises
a flexible band extending around each wheel element and co-extensive with a portion of the rotary screen, wherein the flexible band is made with an outward camber.

11. The printing press as defined in claim 9, wherein the means for providing lateral tensioning comprises:
a flexible band extending around each wheel element and co-extensive with a portion of the rotary screen, and
a nip wheel running on the flexible band with a canted axis relative to the axis of the mandrel.

12. The printing press as defined in claim 9, wherein the two wheel elements disposed at opposite ends of the one of the mandrels are drive wheels, and wherein the means for providing lateral tensioning comprises an axis of rotation of the two drive wheel elements being disposed at an outward angle relative to the axis of the one mandrel on which it is disposed.

13. The printing press as defined in claim 1, wherein the ink repository is disposed between the wheel elements on at least one of the mandrels adjacent the rotary screen and includes therein an element for forcing ink through the rotary screen to a substrate, wherein the element for forcing ink is radially adjustable and/or tangentially adjustable relative to the rotary screen.

14. The printing press as defined in claim 13, wherein the element for forcing ink comprises a squeegee holder holding a squeegee, with the squeegee holder rotating around an eccentric disposed around one of the mandrels to adjust the squeegee radially.

15. The printing press as defined in claim 13, wherein the element for forcing ink comprises a squeegee holder holding a squeegee and rotating around an eccentric disposed around one of the mandrels to adjust the squeegee radially, wherein the eccentric is rotatable to adjust the squeegee tangentially.
